(19) United States
(12) Patent Application Publication
(10) Pub. No.: US 2025/0156126 A1
(43) Pub. Date: May 15, 2025

(54) METHOD FOR EVALUATING DATA OF A PRINTING MACHINE

(71) Applicant: manroland Goss web systems GmbH, Augsburg (DE)

(72) Inventor: Alexander SAILER, Zusmarshausen (DE)

(21) Appl. No.: 18/949,433

(22) Filed: Nov. 15, 2024

(30) Foreign Application Priority Data
Nov. 15, 2023 (DE) 10 2023 131 836.5
May 24, 2024 (DE) 10 2024 114 701.6

(51) Int. Cl. G06F 3/12

(52) U.S. Cl. CPC G06F 3/121; G06F 3/1273

(57) ABSTRACT

The invention relates to a computer-implemented method for analyzing data of a printing machine during or after a production, wherein a number of printed products with a specified target printing technology value are produced by the printing machine during at least one print job, wherein actual machine data and/or actual printing technology values and/or production data and/or machine interference signals and/or control signals and/or an operating signal are detected and/or stored over a period of time by a computing device across a portion of the at least one print job. It is the object of the invention to evaluate the large data volumes and the very large number of measuring values and signals by means of a computer-implemented method, in order to find causes for production disruptions and to be able to increase the productivity of a printing machine.

### CROSS-REFERENCE TO RELATED APPLICATIONS

This application claims priority to German Patent Application No. 10 2024 114 701.6, filed on May 24, 2024, and German Patent Application No. 10 2023 131 836.5, filed on Nov. 15, 2023, the entire contents of all of which are incorporated by reference herein.

### DESCRIPTION

The invention relates to a computer-implemented method for detecting and analyzing data of a printing machine during or after a production for the evaluation and for the productivity optimization, wherein a defined number of printed products with at least one specified target printing technology value are produced by the printing machine during at least one print job, wherein one or several actual machine data and/or one or several actual printing technology values and/or one or several production data and/or one or several machine interference signals and/or at least one control signal and/or at least one operating signal are detected and/or stored over a period of time by a computing device across at least a portion of the at least one print job.

Modern printing machines, such as, for example, web-fed printing machines, are highly complex systems, in the case of which substrates with very high demands with respect to interference variables, such as, for example, paper with a very high susceptibility for web breaks in response to web tension fluctuations or excessive moistening, can be printed with very high substrate speeds of up to 17 meters per second and very high substrate widths of up to 2,860 millimeters with a high variability of production options, substrates, substrate widths and consumable materials with very high quality demands, such as, for example, permissible color register deviations of a few micrometers.

Approximately 20 computers, hundreds of sensors and other devices for detecting or for determining data are thus used, for example, in the case of a conventional commercial web-fed printing machine with four printing units for the two-sided four-colored printing of a paper web and a folding unit with approximately 50 electric drives. For example, a modern drive motor can thus be monitored with respect to twenty one parameters. In the case of a relatively complete monitoring of a web-fed printing machine, over 20,000 data sets can thus accumulate in only one second, which usually corresponds to a detectable data volume of over 20 gigabyte (GB) per day.

Due to the presets and due to the high degree of automation, printing machines of this type are thus highly efficient and can also be evaluated and thus assessed to a large degree with respect to the productivity. Due to the large data volumes and the large number of detected data, however, it has become increasingly more difficult at the same time to recognize or find the causes of machine malfunctions or disruptions of the production, especially because with an increasing number of drives, sensors, computers, etc., the number of potential errors and thus the number of potential error messages can also increase and the setting options but also the adjusting options of parameters etc. have increased for the operating personal at the same time. Due to the large number of the components integrated in a printing machine and the respective optimization thereof, a regulation also takes place within a component of this type, which generally should not have and normally does in fact not have any effect on the overall functionality of the printing machine, but can in fact have an effect on the behavior of the overall machine in individual cases, that is, under special production conditions and/or in cooperation with such other control or regulating processes of other components.

It is thus the object of the present invention to evaluate the large data volumes and the very large number of measuring values and signals per time unit by means of a computer-implemented method, in order to find causes for machine malfunctions or production disruptions and to be able to increase the productivity of a printing machine.

The object is solved in that the one or several actual machine data are stored and/or saved during the production of printed products of the at least one print job as one or several actual production data, and one or several standard machine values are formed as a function of the production data and/or for comparable production data by using artificial intelligence from the actual production data for at least one time span of a defined minimum duration of an at least disruption-free production.

The formation of standard machine values of this type has the advantage that for each of the relevant actual machine data, the corresponding standard machine values are present, in the case of which a disruption-free production is possible over a definable time period, so that the standard machine values can be used as a benchmark or as a reference variable in the event of production disruptions. At the same time, however, the standard machine values determined in this way also do not only serve for the analysis of interference causes but can also be used as basis for a comparison of the machine settings and of the machine parameters of generally comparable printing machines during the production of comparable substrates.

According to one embodiment of the invention, one or several actual machine data, for which deviations are formed for the one or several standard machine values, are stored and/or saved as one or several actual anomaly data.

This embodiment has the advantage that due to the comparison of the actual machine data with the standard machine values, anomalies of the actual machine data can be determined for all essential or relevant parameters, which significantly simplifies the restriction of possible error causes, if, for example in a certain production situation, the power consumption of the drives and/or the web tension as a whole or at a specific point differs significantly upwards or downwards compared to the corresponding standard value. By means of the display or output of these anomalies compared to the standard values, the search for possible error causes for production disruptions can be simplified significantly, which is no longer possible in the case of a manual evaluation of the data due to the data volumes and the occasional brevity of anomalies of this type.

According to a further embodiment of the invention, those actual machine data, for which an anomaly is shown compared to the previous and/or subsequent actual machine data, are stored and/or saved as actual anomaly data.

This embodiment has the advantage that anomalies of actual machine data can also be detected therewith, which either significantly exceed or fall below the standard machine values, or which lie within the standard machine values, but have an anomalous behavior compared to the previous and subsequent values. Due to the fact that an anomaly of this type can be a reason or a consequence of a machine malfunction and/or of a production disruption, this approach provides for a quick determination of possible disruptions.

According to a further embodiment of the invention, those actual machine data, in the case of which at least one specified target machine value is exceeded, are stored and/or saved as actual anomaly data.

According to general experience, the exceedance of a specified target machine value, that is, the exceedance of a specified maximum value of a component, such as, for example, the maximally permissible current consumption of a drive or the exceedance of a web tension defined in a machine section or the exceedance of a specified maximum temperature of a component are indications for an irregularity, which causes the above-specified maximum values and/or occur when correcting these irregularities. The exceedance of specified target machine values thus does not have to mandatorily cause a production disruption, but irregularities of this type occur as a result of an unplanned production state, which, given a sufficient extent, can lead to a production disruption, which is why the recognition of such exceedances of target machine values can be helpful for finding critical machine states.

According to a further embodiment of the invention, those actual machine data, in the case of which at least one specified threshold printing technology value is exceeded, are stored and/or saved as one or several actual anomaly data.

Due to the fact that the exceedance of at least one threshold printing technology value, such as, for example, the color register or the ink density of a printing ink, can be a result of an occurred disruption, such as, for example, of a web tension fluctuation, it is expedient to use the exceeding of a threshold printing technology value as indicator for an irregularity, which occurred previously or simultaneously, in order to thus ensure the search for corresponding causes for disruptions of the production process.

According to a further embodiment of the invention, the computing device additionally detects and/or saves one or several machine interference signals.

Machine interference signals are signals generated by the printing machine, which can occur randomly during normal operation or which are generated in the event of a disruption, such as, for example, a report of a stopper in the folding unit or the report of a web break. A machine interference signal, however, can also comprise a security message, which occurs when entering an area secured by means of a light grid or when opening a secured protective grid. Due to the fact that signals of this type are generally a clear indication for an existing disruption, the detection and evaluation of the machine interference signals is highly advantageous for the recognition of irregularities, production disruptions, disruptions of the control process or for detecting operating errors.

According to a further embodiment of the invention, the one or several actual machine data, in the case of which at least one machine interference signal is generated in the temporal advance and/or in the temporal follow-up, are stored and/or saved as one or several actual anomaly data.

Due to the fact that machine interference signals are generally a clear indication for an existing disruption or for an improper operation, the detection and evaluation of the machine interference signals is highly advantageous for recognizing irregularities, production disruptions, disruptions of the control process or for recognizing operating errors, which are the result of a machine interference signal, which is why it is very helpful to find machine interference signals of this type in order to find the cause of a machine malfunction.

With the use of a very large number of automated and monitored components on modern printing machines, however, the risk also increases that machine interference signals of this type are generated unintentionally and that, due to control processes triggered thereby, machine conditions could be created, such as, for example, the initiation of a secure-hold stop with web break risk, which tends to be higher, so that finding machine interference signals of this type greatly simplifies finding the cause of unwanted disruptions of the production process.

According to a further embodiment of the invention, an error time period, in the case of which one or several actual anomaly data lie in the range of the corresponding one or several standard machine values, is determined and/or saved.

If one or several actual machine data show an anomaly, but which lies within the usual standard machine values, deviations of this type are often not recognized during a normal evaluation of the actual machine data as part of an error search and/or a productivity optimization because no recognizable deviation from the usual standard machine values is at hand.

As part of the present invention it has been found, however, that the occurrence of anomalies of several actual machine data, such as, for example, also seemingly small anomalies of the power consumption of drives, which act successively on the web tension of the substrate web, can lead to production disruptions or quality losses due to an interaction even to a seemingly small extent, when the effects on the web tension add up, for example due to regulating processes of the respective drives, which is why the recognition and detection of anomalies of actual machine data are essential for the error analysis and the subsequent machine optimization even in the range of the standard machine values. A time span before and/or after a machine malfunction or a disruption of the production is hereby considered to be an error time period.

According to a further embodiment of the invention, one or several actual anomaly data and/or the at least one error time period are analyzed with regard to the occurrence of at least one operating signal and/or at least one anomaly and/or at least one control signal.

This embodiment has the advantage that for the error analysis and for increasing the productivity in the time periods, in which corresponding disruptions occur or are potentially possible, operating signals triggered by the operating personnel are sought for activating various functions, such as, for example, the triggering of a print run washing process and/or control signals are sought, which are triggered by the machine control or by the component controls for carrying out various operating steps, such as, for example, the triggering of a roll changing process or the start-up of the exhaust fans of hot air driers after triggering a rubber blanket washing process, by means of a computer-implemented method, so that a temporal sequence of the operating signals and/or of the control signals, together with the influence thereof on actual machine data can be analyzed and can be used for the error elimination in spite of the very large data volumes.

According to a further embodiment of the invention, at least one data set of one or several actual machine data and/or at least one operating signal and/or at least one control signal is determined and/or output and/or visualized as potential cause for one or several actual anomaly data and/or for at least one error time period and/or for at least one machine interference signal.

A data set of this type has the advantage and the option to document and to visualize situations of this type with occurred disruptions or with potentially occurring disruptions or with influencing of the printing quality with the relevant actual machine data, the occurred anomalies as well as the used operating signals, control signals, etc., in an automated manner, in order to then have them further assessed by an additional software or to have them assessed by an expert, in order to be able to draw conclusions for avoiding machine processes of this type in this way.

According to a further embodiment of the invention, a plausibility check of the at least one data set is carried out. During this plausibility check, it is checked whether the actual machine data with corresponding anomalies and/or the operating signals and/or control signals documented in the detected error time period are generally compatible with one another. It is thus rather not plausible, for example, that due to web tension fluctuations and/or anomalies in the drive torques of the motors in the roll changer have in a temporally close relationship with a splicer in a folding unit. It is further rather not plausible that anomalies of the sensor signals of a drive cause register deviations in a folding unit in a specific printing unit. The plausibility of the data, which are detected and which are correlated with one another, can thus be checked by means of the computer-implemented method by means of stored logical connections of this type, in order to improve the quality of the error analysis.

According to a further embodiment of the invention, the plausibility check is used to optimize the used artificial intelligence. For this purpose, the stored database can be optimized accordingly with an increasing number of performed plausibility checks, for example also by means of an input by an operator, so that the reliability of the plausibility check can be increased by means of the optimization of the used artificial intelligence.

According to a further aspect of the invention, the at least one standard machine value is divided with respect to the production data for different production phases and production states and are stored in a memory device and/or output by the latter.

It is possible hereby to determine and store and/or output at least one standard machine value, that is, a value or mostly a value range for an actual machine value, such as, for example, a web tension in a specific machine section, the set advances of draw rollers, the temperature profile in a printing unit or in the cooling unit, etc., with which a disruption-free production of printed products is generally possible, for different production states, such as the start-up, the setup operation, the print run operation or the print run washing.

It is possible herewith that a synchronization of the set and/or of the available actual machine data with the standard machine values already takes place during the production, so that production disruptions due to incorrect settings of the printing machine, for example by the operating personnel, can be avoided and the production stability is increased.

It is additionally possible with this method to not only operate the corresponding printing machine with an even higher production reliability but the data collected in this way can also be used for other identically constructed or similar printing machines with optimization potential of the production stability.

According to a further embodiment of the invention, the standard machine values are used, with respect to the production data, as one or several preset values for print jobs with identical or comparable production data. Due to this solution, it is possible to use only the standard machine values, with which a stable production of printed products is definitively possible, for the presetting of the printing machine, so that operating errors are avoided due to this automated approach, and to simultaneously ensure preset values for a maximum production stability when loading a new print job with identical or comparable production data due to the permanent optimization of the standard machine values.

According to a further embodiment of the invention, a warning message is generated by the computing device in the event of the occurrence of one or several actual anomaly data and/or an intervention in the control of the printing machine takes place when one or several actual anomaly data exceed at least one anomaly threshold value.

Due to this aspect, the computer-implemented method cannot only be used for the data protection and data analysis after disruptions or printing technology-related problems have occurred and for avoiding them in the future. On the contrary, it is also possible with this embodiment to already generate a warning message and/or to actively intervene in the machine control in the case of potential problems of the production stability or of the printing quality, for example by reducing the printing speed, so as to thus avoid production disruptions, for example due to web breaks or the printing of waste and/or to draw the attention of the operating personnel to possible irregularities in the production process, even before disruptions occur and in order to avoid them.

Preferred further embodiments of the invention follow from the subclaims and the following description. Different exemplary embodiments of the invention are described in more detail on the basis of the drawings, without being limited thereto, in which:

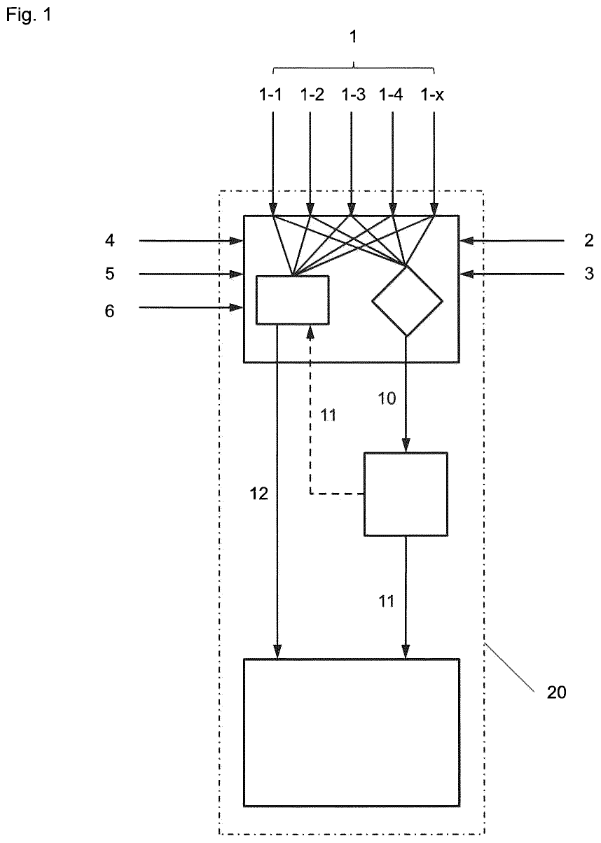

FIG. 1 shows a schematic mode of operation of the method

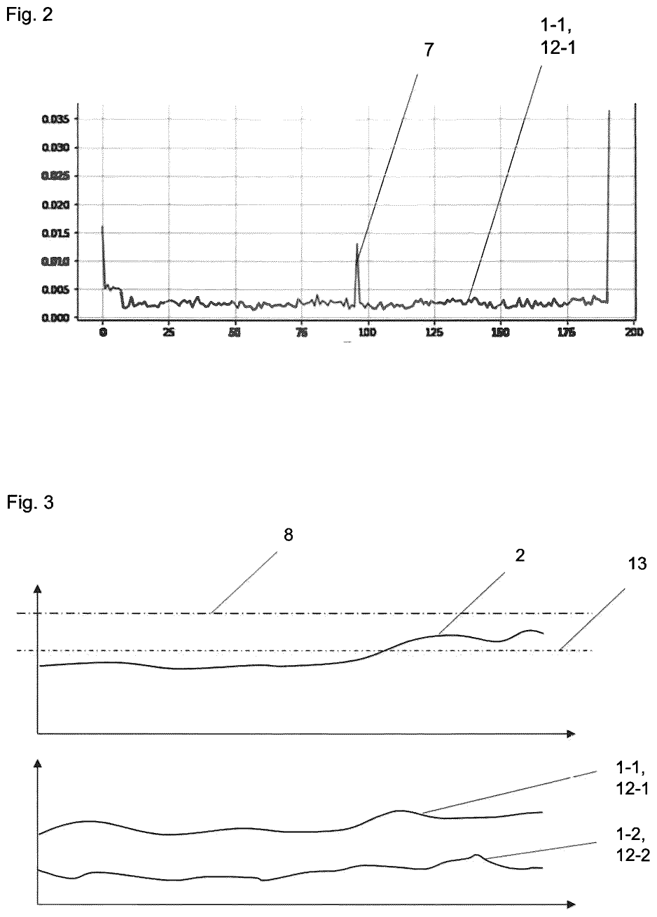

FIG. 2 shows an actual machine date with an anomalous course

FIG. 3 shows an exemplary connection between actual anomaly data and an actual printing technology value

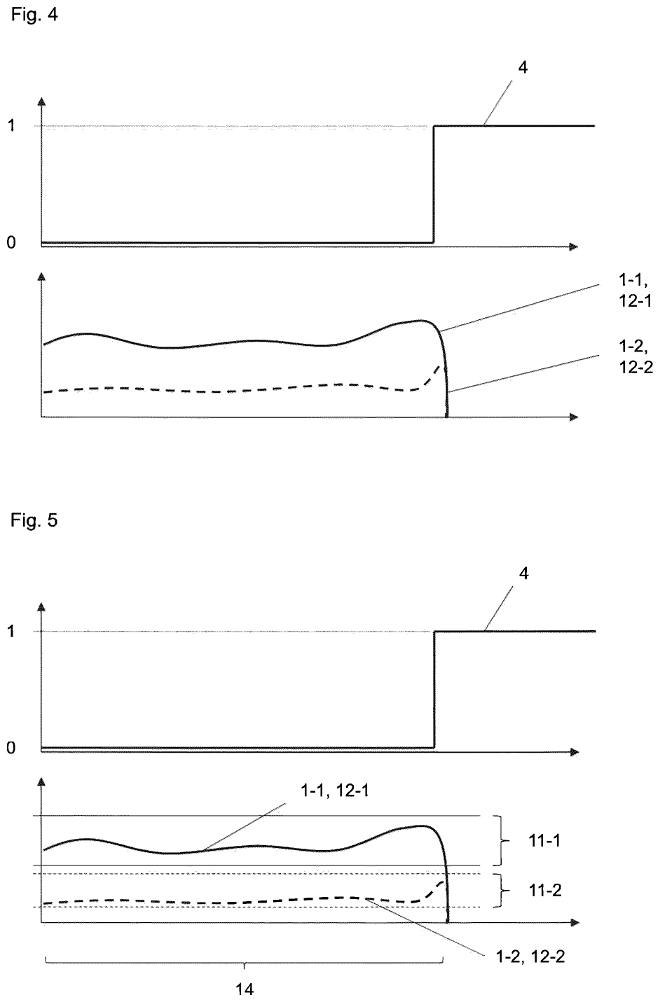

FIG. 4 shows an exemplary course of actual anomaly data with a machine interference signal

FIG. 5 shows an exemplary course of actual anomaly data with a machine interference signal and an error time period

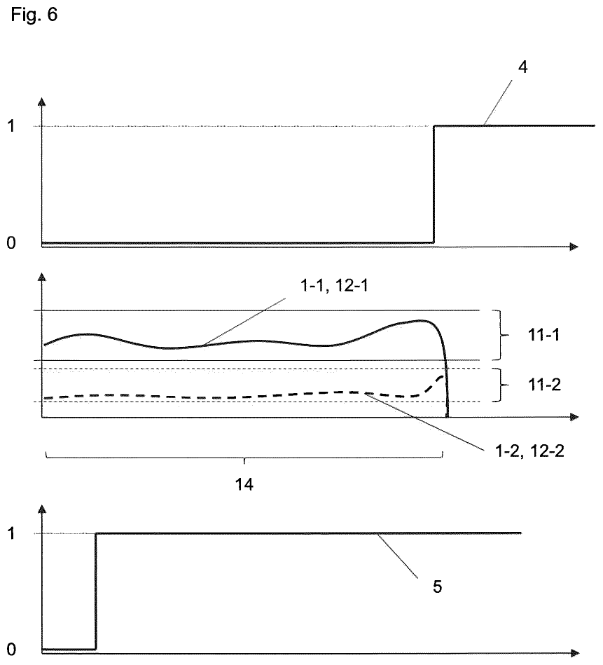

FIG. 6 shows an exemplary course of actual anomaly data with a machine interference signal and an error time period in connection with a control signal

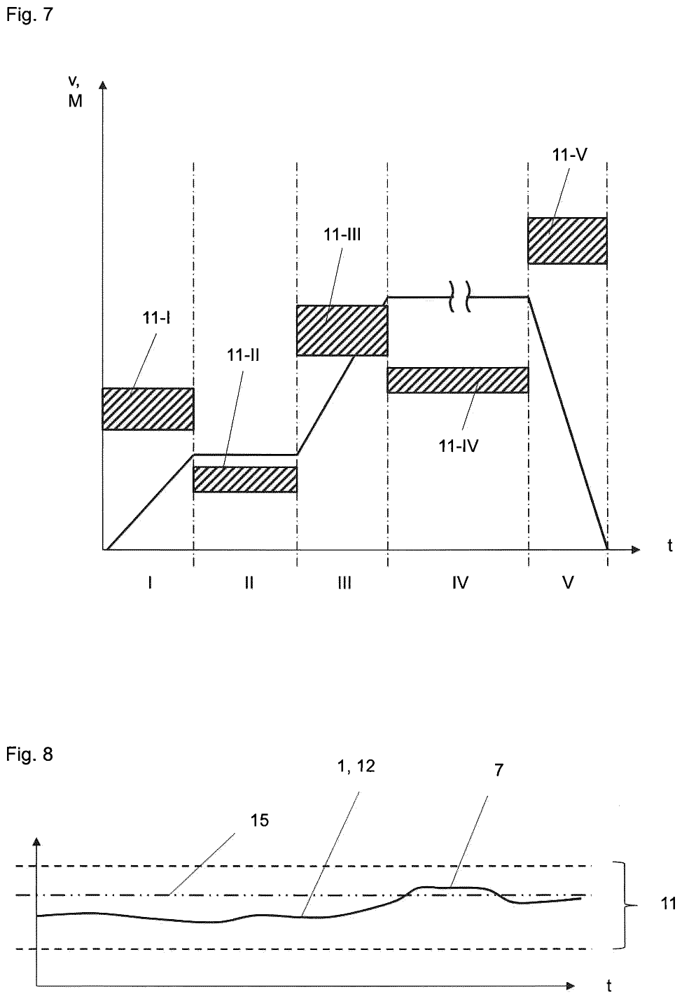

FIG. 7 shows the connection of an exemplary standard machine value with production phases

FIG. 8 shows an actual anomaly date when exceeding an anomaly threshold value

FIG. 1 shows a schematic illustration of the method for evaluating the data of a printing machine. To begin with, however, a definition of the used terms is absolutely necessary for a better understanding.

In the present invention, the term “data” is to be understood both as a fixed value, which is either constant over a corresponding time period, such as, for example, target data, such as, for example, a ink density specified for a printing ink, as target printing technology value 8. However, data can also be the temporal sequence or the stringing together, respectively, of measuring values or detected values or of determined values over a certain time period, such as, for example, the current consumption of a drive motor or the advance of a draw roller or the temperature of a component part or of a fluid determined by a temperature sensor or the register deviation of a printing ink from a different printing ink as actual printing technology value 2.

The physical data, which are detected permanently or in a cyclically manner and/or which are determined permanently or in a clocked manner by various sensors and which are detected or determined in the printing machine by the component parts or components thereof, are referred to as actual machine data 1. Examples are physical data, such as the different drive parameters (current intensity, voltage, phase shift, rotational speed, etc.) of a drive motor, web tension values at different measuring points, the actually determined web width, which can change due to the web tension or, for example, the fan-out effect, the ink zone opening, the rotational speed of an ink ductor or moistening agent ductor, the image regulator setting, advances of various drives and/or of various components, the production speed as well as the temporal courses of these detected or determined data.

Certain parameters, which must not be fallen below and/or but not exceeded by the different components because otherwise there is the risk of a disruption or of a damage, are referred to as target machine values 9. Examples for target machine values 9 are maximum current intensities of a drive motor, the maximum torque of a drive motor, a web tension maximally permissible in a component, a maximum temperature of a component, a minimum temperature of a component or of a fluid or the like.

The detected actual printing technology values are referred to as actual printing technology values 2, that is, these are the detected or determined data, which allow for an assessment of the print image of the printed products. The determined ink density, the tone value increase, the color register deviation, a determined tone detection value, certain doubling values or factors, values for determining a fan-our effect, diagonal register deviations, etc., are examples for an actual printing technology value 2.

Target printing technology values 8 are the specifications for the printing quality of a printed product to be printed, such as, for example, the target color densities for the used basic colors, permissible register deviations, a permissible fan-out effect or a permissible tone value increase for a specific grid. When exceeding or falling below at least one target printing technology value 8 of a printed product, the latter is to thus no longer be referred to as good product and is thus waste.

Threshold printing technology values 13 are specifications for the printing quality, such as, for example, a ink density for a basic color, color register deviations to still be accepted, tone value increases to still be accepted, etc., Threshold printing technology values 13 are thus the values, at which a good product is still present but certain, albeit acceptable quality compromises are already present, which, however, are to be regarded as an indicator for the production of waste with further degradation.

Production data 3 are fixed data, which are generally unchangeable for a production, that is, for a print job, which are specified and which define a production in terms of a print job. Examples for production data 3 are the substrate type, the paper type or paper quality, the grammage, the web width to be used, the required fold type, the printing ink to be used, additives to be used, such as, for example, the moistening agent to be used or the like.

As machine interference signals 4 are generated by the printing machine or by the components installed in the printing machine and indicate a disruption. Examples for machine interference signals 4 are, for example, a stopper message in the folding unit, a message about a web break triggered by a web break sensor, a message from the waste gate and thus the production of waste, that is, of printed products with at least one non-reached target printing technology value 8, an overload signal of an electric drive or security messages, such as the signal of an area protection for an unauthorized penetration or the opening of a protective grid monitored by means of a safety switch.

Operating signals 6 are generally commands or signals triggered by the operator, such as, for example, the machine start, the machine stop, a faster-signal for increasing the production speed, a slower-signal for reducing the production speed, the actuation of a secure-hold button or the like.

Control signals 5 are machine signals, which are either generated by the machine control of the printing machine or by controls of the components, such as, for example, of a roll changer, a hot air drier or a rubber blanket washing system, in order to control internal processes. Examples for control signals 5 are a signal of a roll changer for carrying out a roll change, a signal for initiating the imprint change after reaching a target run, control commands of the cutting register or of the color register regulating device, etc.

Actual production data 10 are the actual machine data 1, in the case of which a disruption-free production can be operated at least over a time period, which is to be defined. Good products are hereby generally also produced, but this is not a mandatory requirement, provided that the production is possible without disruption, that is, without web breaks, stoppers, etc. because the actual printing technology values 2 are irrelevant, for example for the assessment of an optimal web tension, for example due to required ink zone settings.

The actual machine values or ranges of actual machine values, in the case of which a disruption-free production is possible, are referred to as standard machine values 11. Standard machine values 11 can be absolute values, but very often cover a certain web width in terms of a permissible range. However, the standard machine values 11 can be a function of the production data 3, such as, for example, the type of the printing material, the grammage, the width of the substrate to be printed, etc., Examples for standard machine values 11 are, for example, the range of a web tension at a specifically arranged measuring roller, usual current consumptions, power consumptions or torques of drive motors, certain advances of various driven elements, in the case of which a disruption-free production is possible in a stable manner for a certain time period.

Those actual machine data 1 or also actual printing technology values 2, which either have deviations or anomalies 7 from the previous and/or the following actual machine data 1, such as, for example, a highly fluctuating, irregular course, are hereby referred to as actual anomaly data 12. However, those actual machine data 1, which exceed the target machine values 9 or at which target printing technology values 8 or threshold printing technology values 13 are exceeded or at which machine interference signals 4 occur during operation, are also referred to hereby as actual anomaly data 12. In summary, actual anomaly data 12 are those actual machine data 1, which show and/or cause anomalies 7 of actual machine values 1 but also of the print production and thus show and/or cause anomalies and/or at which disruptions occur and a disruption-free production is thus not possible.

A disruption-free production is thus a production without machine- or substrate-related disruptions, such as stoppers, web breaks, occurring overloads, unacceptable web courses, fold formation, etc.,

A production phase or a production state is a special phase during a production, such as, for example, the setup phase, the print run, the print run washing or the production end.

FIG. 1 thus shows, in a purely schematic manner, the computing device 20, which detects one or several actual machine data 1 and/or one or several actual printing technology values 2 and/or one or several production data 3 and/or one or several machine interference signals 4 and/or at least one control signal 5 and/or at least one operating signal 6 over at least a portion of the at least one print job and/or stores them over a period of time. In the case of the example illustrated in FIG. 1, the computing device 20 detects a plurality of actual machine data 1-1 to 1-x, for example various drive parameters of the different drives of the printing machine, the web tension at different measuring devices within the printing machine, the actual production speed, the web widths upstream of and downstream from the printing units and optionally many other detectable or determinable parameters.

The computing device 20 can either be a part of the control device of a printing machine, but the computing device 20 can also be arranged outside of the printing machine, which is not illustrated in FIG. 1, and can also be located outside of the corresponding print shop, for example at a printing machine manufacturer, provided that the corresponding data are transmitted there via a data line, which is not illustrated in FIG. 1.

The one or the several actual machine data 1 are initially analyzed as to whether they originate from a time span of a defined minimum duration of a continuing disruption-free production, in order to avoid that the actual machine data 1 originate from a production or from a time period of a production, which is highly prone to disruption. Even though a print production of this type, which is prone to disruption, are not mandatorily attributable to problems of the printing machine because they originate, for example, from a defective or inferior printing material, it should be ruled out nonetheless that standard machine values 11 originate exclusively from disruption-fraught production windows because it can initially not be ruled out that such disruptions of a production originate from an inexpert setting or use of the printing machine.

If the detected or the determined actual machine data 1 originate from an ample production, these actual machine data 1 are stored and/or saved as actual production data 10. As a function of the production data 3 of the respective print job, at least in one or several standard machine values 11 are then formed from these actual production data 10 of at least one time span with a defined minimum duration of a disruption-free production, which preferably takes place via the use of artificial intelligence. As already specified above, the standard machine values 11 determined in this way represent the data or physical variables, under corresponding production conditions, which are represented in particular by the production data 3, which physical variables are normally present during the operation of a disruption-free production of this type.

As can further be seen from FIG. 1, one or several actual machine data 1 are analyzed with regard to anomalies 7 and those actual machine data 1, which have below-described deviations from the corresponding standard machine values 11, are stored and/or saved as one or as several actual anomaly data 12.

For example, the actual machine data 1, in the case of which an anomaly 7 is shown compared to the previous and/or the subsequent actual machine data 1, can be stored and/or saved as actual anomaly data 12.

FIG. 2 shows, in a purely exemplary manner, a first actual machine data set 1-1, such as, for example, the advance of a drive motor over a defined time unit. While this detected or determined variable usually assumes a value of between 0.02 and 0.03 and lies in a completely normal value range in this range, a corresponding anomaly 7 takes place, for instance, in the case of the time unit 95 because the actual machine data set 1-1 assumes a value of approx. 0.013 there and is thus higher than normal approximately by the factor of 6.

Due to this anomaly 7, this first actual machine data 1-1 is detected and/or stored and/or saved as a first anomaly date 12-1 due to the irregularity.

However, those actual machine data 1, in the case of which at least one specified target machine value 9 is exceeded, can also be defined and/or stored and/or saved as actual anomaly data 12.

If, for example, the maximum current consumption and thus the target machine value 9 for a drive is twenty amperes and if it is at least occasionally exceeded because the current consumption increases to up to twenty three amperes, this actual machine data 1 is defined and/or stored and/or saved as an actual anomaly date 12 due to the exceedance of the target machine value 9.

Those actual machine data 1, in the case of which a specified threshold printing technology value 13 is exceeded during the production, can also be defined and/or stored and/or saved as actual anomaly data 12.

FIG. 3 shows an example of this type, in the case of which the temporal course of two actual machine data 1-1, 1-2, which are relevant for the actual printing technology value 2 of the color register deviation, such as, for example, the phase shift of the drive motor of a first printing unit and the phase shift of the drive motor of the second printing unit to the guide value of the virtual guide axis, is illustrated. The two actual machine data 1-1 and 1-2 generally move within the normal range, but a certain increase can nonetheless be recognized starting approximately at half of the detected or illustrated time, which is noticeable with only small temporal offset in an increase of the detected actual printing technology value 2, such as, for example, the color register deviation between the first printing unit and the second printing unit.

Even though in the example illustrated in FIG. 3, the actual printing technology value 2 is always still significantly below the permissible target printing technology value 8, which defines the maximally permissible color register deviation in this example, the actual printing technology value 2 already exceeds a threshold printing technology value 13, which is specified below the target printing technology value 8, which is why the computer-implemented method determines an anomaly 7 hereby because the exceedance of the threshold printing technology value 13 acts as a type of early warning system before reaching the target printing technology value 8 and the production of waste copies resulting therefrom.

As illustrated in FIG. 1, it is also possible that the computing device 20 also detects one or several machine interference signals 4 in addition to the above-mentioned data. Machine interference signals 4, such as, for example, messages from web break detectors or from stopper sensors can also be detected by means of the computing device 20 because an interference signal 4 detected by sensors of this type is often a proof of or the consequence for, respectively, an anomaly 7 that occurred previously.

It is possible hereby that the one or optionally several actual machine data 1 are stored or saved as one or optionally as several actual anomaly data 12, in the case of which at least one machine interference signal 4 is generated in the temporal advance or in the temporal follow-up.

FIG. 4 shows a schematic example of this type, in the case of which the course of two actual machine data 1 is shown in the lower diagram, for example the torque course 1-1 of a drive motor and the web tension 1-2 resulting therefrom as dashed line. After an originally normal course of the torque 1-1, the latter increases accordingly, whereupon the web tension 1-2 increases accordingly as a result thereof. Due to the increase of the web tension 1-2, the substrate web breaks, which is why a machine interference signal 4 is triggered, namely for example that a web break sensor reports a web break, so that the value of this machine interference signal 4 increases from a value of zero to the value of one. Due to the web break, the drive torque 1-1 and the web tension 1-2 as actual machine data 1 drop to the value of zero.

Due to the detection of machine interference signals 4, it is thus possible to define and/or to store and/or to save the relevant actual machine data 1 as corresponding actual anomaly data 12.

FIG. 5 shows the slightly modified example from FIG. 4, in the case of which the first actual machine date 1-1 lies within the first standard machine value 11-1 and in the case of which the second actual machine date 1-2 lies within the second standard machine value 11-2 and generally do not show a particular anomaly for this reason. Due to the machine interference signal 4, which occurred subsequently, however, an error time period 14 is determined, in which the relevant actual machine data 1 are detected, even if they lie within the respective standard machine values 11 and thus allegedly do not show any anomalies.

By means of this definition of the error time period 14 with the relevant actual machine data 1 stored therein, which are defined and/or stored and/or saved as actual anomaly data 12 due to the occurrence of a machine interference signal 4, this error time period 14, which usually has the duration of a few seconds up to a few minutes, the occurrence of at least one operating signal 6 and/or of at least one anomaly 7 and/or of at least one control signal 5 can thus be analyzed.

It is thus possible by means of the computer-implemented method that at least one data set of one or several actual machine data 1 and/or at least one operating signal 6 and/or at least one control signal 5 is determined and/or output and/or visualized as potential cause for one or several actual anomaly data 12 and/or for at least one error time period 14 and/or for at least one machine interference signal 4.

FIG. 6 shows the example from FIG. 5, in the case of which an additional control signal 5, such as, for example, the activation of a rubber blanket washing system or an imprint change could also be found. It can be recognized hereby that in a temporal follow-up of the control signal 5, which is in fact quite large, the first actual machine date 1-1 has an increasing anomaly 7, which resulted in an anomaly 7 of the second actual machine date 1-2 and thus led to a machine interference signal 4, such as, for example, the signal of a web break sensor.

In a special embodiment, a plausibility check of the at least one data set can be carried out hereby in particular by means of artificial intelligence, in order to avoid that actual machine data 1 and/or operating signals 6 and/or control signals 5 are observed, which cannot be associated with the created machine interference signal 4.

It is optionally possible hereby that the plausibility check is used to optimize the used artificial intelligence. For this purpose, the stored database can be optimized accordingly with an increasing number of plausibility checks, which are carried out, for example also by means of an input of an operator, so that the reliability of the plausibility check can be increased by means of the optimization of the used artificial intelligence.

It is additionally possible that the at least one standard machine value 11 can be divided with respect to the production data 3 for different production phases and production states and can be stored in a memory device and/or output by the latter.

FIG. 7 shows a purely schematic example of this type for different standard machine values 11 using the example of the drive torque M of a drive motor as standard machine value 11 for different operating states.

The time t is plotted on the abscissa, the machine speed v as well as the torque M for the standard machine values 11 is plotted on the ordinate. The line shows an exemplary course for the printing speed v for a conventional production, which is divided into different production phases I to V, which are specified with Roman numerals.

The production phase I is the so-called start-up phase, in the case of which the printing machine is accelerated to a setup speed. Due to the acceleration of the corresponding components and printing cylinders, a torque of the drive, which is not too small, is required as corresponding standard machine value 11-1 in the start-up phase I and is thus also permissible as standard machine value 11-1.

The production phase II is the so-called setup phase, in the case of which the corresponding components, such as, for example, the printing units, are set up and/or adjusted at a speed, which is not too high, so that the required printing quality and/or the corresponding fold quality is reached. Due to the constant and not particularly high machine speed v, the torque M is not particularly high in this production phase II, which is why the corresponding standard machine value 11-II lies below the standard machine value 11-1.

The production phase III is the acceleration phase, in which the printing machine is accelerated to the corresponding production speed and the web tension has to be maintained at the same time, so that a very high drive torque M is usually required in this production phase III, which is why the permissible drive torque as standard machine value 11-III is correspondingly large in the production phase III and a larger range is also possible and thus permissible.

The production phase IV is the print run phase, in the case of which the printing machine is operated with a print run speed, which is as constant as possible. Due to the acceleration of the corresponding components, which is no longer required, the torque of the corresponding drive is correspondingly smaller in this production phase IV, the torque is to additionally be kept very constant hereby, which is why the standard machine value 11-IV is smaller than the standard value III and additionally has a smaller permissible range.

The production phase V is the wind-down phase, in the case of which the printing machine is decelerated after or for reaching the target print run. Due to the deceleration process, the amount of the torque required for this purpose is thus higher, which is why the standard machine value 11-V is larger in the production phase V than in the previous production phases I to IV.

By storing different standard machine values 11 for different production phases I to V, the assessment of the actual machine data 1 as actual anomaly data 12 can thus be used in a correspondingly differentiated manner during the different production phases, in order to increase the efficiency of the error assessment.

According to a further embodiment, the standard machine values 11 are used with respect to the production data 3 as one or several preset values for print jobs with identical or comparable production data 3.

Due to the fact that the standard machine values 11 represent the permissible and/or required ranges or values for the actual machine data 1, these determined standard machine values 11 can be used to preset a printing machine, in order to avoid corresponding operating errors. Due to the fact, however, that the standard machine values 11 can be a function of the production data 3, a differentiation of the standard machine values 11 is also possible with respect to the production data 3.

For example, the required but also the permissible web tension thus increases with the web width of the printing material as well as generally with the grammage of the printing material. However, completely different ranges of the web tension can be required and/or permissible again for different types of printing materials, such as, for example, uncoated paper, coated paper or even for a plastic film to be printed, which is why an assignment of the standard machine values 11 to the production data 3 is also obvious or required.

However, standard machine values 11, which were determined for a first production with first production data 3-1, can therefore also be used for the presetting for a production with two production data 3-2, provided that the second production data 3-2 differ from the first production data 3-1 within reasonable limits, that is, that the second production data 3-2 are comparable with the first production data 3-1.

According to a further embodiment of the invention, a warning message is generated by the computing device 20 in the event that one or several actual anomaly data 12 occur and/or an intervention in the control of the printing machine takes place when one or several actual anomaly data 12 exceed at least one anomaly threshold value 15.

Due to this embodiment, the computer-implemented method cannot only be used for the data protection and data analysis after disruptions or printing technology-related problems have occurred and for avoiding them in the future. On the contrary, it is also possible with this embodiment to already generate a warning message and/or to actively intervene in the machine control in the case of potential problems of the production stability or of the printing quality, for example by reducing the printing speed, so as to thus avoid production disruptions, for example due to web breaks or the printing of waste and/or to draw the attention of the operating personnel to possible irregularities in the production process, even before disruptions occur and in order to avoid them.

FIG. 8 shows an exemplary course of an actual machine date 1 over the time t, wherein this actual machine date 1 has an anomaly 7 because the values have an anomalous behavior compared to the previous time period, which is why this actual machine date 1 was recognized, detected, stored and/or saved as actual anomaly date 12. Even though this actual anomaly date 12 still lies within the corresponding standard machine value 11 and disruptions are to thus generally be expected, this actual anomaly date 12 thus nonetheless exceeds a defined anomaly threshold value 15.

In order to avoid a further increase of the actual machine date 1 and thus of the actual anomaly date 12 all the way to the upper threshold value of the standard machine value 11, because this exceedance of the standard machine value 11 can, according to experience, be associated with corresponding problems, either a warning message, preferably with instructions for action, is generated as early reaction to an exceedance of the anomaly threshold value 15 and/or an active intervention in the control of the printing machine is performed, in order to avoid potential problems in a preventative manner. An intervention in the control of the printing machine can be, for example, a reduction of the printing speed or the at least temporary suppression of control signals 5, which are not mandatorily required, such as, for example, the avoidance of washing processes.

### LIST OF REFERENCE NUMERALS

1 actual machine data
2 actual printing technology values
3 production data
4 machine interference signal
5 control signal
6 operating signal
7 anomaly
8 target printing technology value
9 actual machine value
10 actual production data
11 standard machine values
12 actual anomaly data
13 threshold printing technology value
14 error time period
15 anomaly threshold value
20 computing device

1. A computer-implemented method for detecting and analyzing data of a printing machine during or after a production for the evaluation and for the productivity optimization, wherein a defined number of printed products with at least one specified target printing technology value are produced by the printing machine during at least one print job, wherein one or several actual machine data and/or one or several actual printing technology values and/or one or several production data and/or one or several machine interference signals and/or at least one control signal and/or at least one operating signal are detected and/or stored over a period of time by a computing device (20) across at least a portion of the at least one print job, characterized in that the one or several actual machine data are stored and/or saved during the production of printed products of the at least one print job as one or several actual production data, and one or several standard machine values are formed as a function of the production data and/or for comparable production data by using artificial intelligence from the actual production data for at least one time span of a defined minimum duration of an at least disruption-free production.

2. The computer-implemented method according to claim 1, characterized in that one or several actual machine data are stored and/or saved as one or several actual anomaly data, for which deviations are formed for the one or several standard machine values.

3. The computer-implemented method according to claim 1, characterized in that those actual machine data, for which an anomaly is shown compared to the previous and/or subsequent actual machine data, are stored and/or saved as actual anomaly data.

4. The computer-implemented method according to claim 1, characterized in that those actual machine data, in the case of which at least one specified target machine value is exceeded, are stored and/or saved as actual anomaly data.

5. The computer-implemented method according to claim 1, characterized in that those actual machine data, in the case of which at least one specified threshold printing technology value is exceeded, are stored and/or saved as one or several actual anomaly data.

6. The computer-implemented method according to claim 1, characterized in that the computing device additionally detects and/or saves one or several machine interference signals.

7. The computer-implemented method according to claim 6, characterized in that the one or several actual machine data, in the case of which at least one machine interference signal is generated in the temporal advance and/or in the temporal follow-up, are stored and/or saved as one or several actual anomaly data.

8. The computer-implemented method according to claim 7, characterized in that at least one error time period, in the case of which one or several actual anomaly data lie in the range of the corresponding one or several standard machine values, is determined and/or saved.

9. The computer-implemented method according to claim 2, characterized in that one or several actual anomaly data and/or the at least one error time period are analyzed with regard to the occurrence of at least one operating signal and/or at least one anomaly and/or at least one control signal.

10. The computer-implemented method according to claim 9, characterized in that at least one data set of one or several actual machine data (1) and/or at least one operating signal and/or at least one control signal is determined and/or output and/or visualized as potential cause for one or several actual anomaly data and/or for at least one error time period and/or for at least one machine interference signal.

11. The computer-implemented method according to claim 10, characterized in that a plausibility check of the at least one data set is carried out.

12. The computer-implemented method according to claim 11, characterized in that the plausibility check is used to optimize the used artificial intelligence.

13. The computer-implemented method according to claim 1, characterized in that the at least one standard machine value is divided with respect to the production data for different production phases and production states and is stored in a memory device and/or output by the latter.

14. The computer-implemented method according to claim 13, characterized in that with respect to the production data, the standard machine values are used as one or several preset values for print jobs with identical or comparable production data.

15. The computer-implemented method according to claim 2, characterized in that a warning message is generated by the computing device in the event of the occurrence of one or several actual anomaly data and/or an intervention in the control of the printing machine takes place when one or several actual anomaly data exceed at least one anomaly threshold value.
